(19) United States
(12) Patent Application Publication
(10) Pub. No.: US 2026/0148597 A1
(43) Pub. Date: May 28, 2026

(54) COMPUTER-IMPLEMENTED SYSTEMS AND METHODS FOR GEOLOCATION-BASED MOBILE LOCK SYSTEMS

(71) Applicant: Boxlty Access Systems, Inc., York, PA (US)

(72) Inventors: Michael Watroba, York, PA (US); Alberto Romero, York, PA (US)

(21) Appl. No.: 18/958,940

(22) Filed: Nov. 25, 2024

(51) Int. Cl. G07C 9/00

(52) U.S. Cl. CPC G07C 9/00309; G07C 2009/00325

(57) ABSTRACT

A mobile lock system includes a lock housing; a moveable element operable in a locked position and an unlocked position; an electronically-actuated latching mechanism disposed within the housing and configured to engage the moveable element when the moveable element is in the locked position, and disengage from the moveable element for moving into the unlocked position; a network interface; a sensor for sensing a characteristic related to a user attempting to unlock the locking system, an interface for receiving geolocation information and a processor, wherein the processor causes the network interface to transmit to a computer server geolocation information and information indicative of a sensed characteristic related to the user attempting to unlock the locking system, and wherein the processor processes a response signal received by the network interface from the computer server to control the latching mechanism to enable said moveable element to move into the unlocked position.

### FIELD OF THE INVENTION

This patent specification relates to the field of providing lock systems for mobile applications. More specifically, this patent specification relates to mobile computer-implemented lock systems and methods thereof for providing controllable unlocking based in part on geolocation information associated with the lock systems.

All documents cited to or relied upon below are expressly incorporated herein by reference.

### BACKGROUND

Prior art electronically-controllable locking systems, such computer-implemented smart locks have grown in popularity to enable individuals to gain access to an enclosure or secure area based on credentials of the individual seeking to gain access that is verifiable by an internet-accessible computer server maintaining information databased with the credentials of who may gain access.

One example of such system for computer-implemented systems that enable access to secure enclosures is disclosed in the Applicants' U.S. Pat. No. 10,922,909. In accordance with the disclosed systems in that patent, a secure lockable enclosure includes an electronically-actuated latching mechanism coupled to a door; a network interface; a sensor for sensing a characteristic related to a user attempting to gain access to a compartment therein; an environmental controller for heating and/or cooling the compartment; and a processor. The processor being adapted to (i) cause the network interface to transmit information indicative of a sensed characteristic of a user attempting to gain access to the compartment and capable of processing an unlock signal, and (ii) control the environmental controller based on a characteristic of an item placed in the compartment.

Traditional methods of delivery and storage frequently result in valuable or perishable goods being left unattended, creating significant risks of theft or tampering. This is particularly problematic in the logistics sector, where high-value items and sensitive goods like pharmaceuticals and military equipment are vulnerable when left unsupervised. Many sensitive items require stringent environmental conditions, such as controlled temperature and humidity, to prevent spoilage or loss. Pharmaceuticals, for example, must be kept within specific temperature ranges to maintain their efficacy. Existing solutions often fail to provide the necessary environmental controls, resulting in the degradation of these items.

In the logistics industry, double brokering-where an authorized driver reassigns the delivery to another driver without the sender's consent-compromises the security and integrity of the transported goods. This practice exposes the shipment to unauthorized access and potential theft. Maintaining an unbroken chain of custody is crucial for items such as pharmaceuticals, military equipment, and high-value logistics shipments. Current systems do not provide sufficient evidence or monitoring to ensure the chain of custody is preserved, which can lead to disputes and security breaches.

While there is real-time tracking of loads and delivery items available, these systems do not enable tracking of who accessed the goods or containers, when the access occurred, and why the access was granted. This gap in tracking and monitoring leaves shipments vulnerable to unauthorized access and tampering, as there is no detailed audit trail of user interactions with the enclosures.

Therefore, a need exists for systems and methods that provide secure mobile locking systems with advanced security features for such logistics, sensitive transportation, military, and pharmaceutical applications.

### BRIEF SUMMARY OF THE INVENTION

The invention provides enhanced security for computer-implemented locking systems for mobile applications.

According to exemplary embodiment consistent with the principles of the invention, an improved mobile lock system includes a lock housing adapted for use with, for example, a mobile structure or enclosure; a moveable element having a first end disposed within and operatively connected to the lock housing, wherein the moveable element is configured to operate in at least a locked position and an unlocked position. Such locking system further includes an electronically-actuated latching mechanism disposed within the housing and configured to engage a second end of the moveable element when the moveable element is in the locked position, and disengage from the moveable element to enable said moveable element to move into the unlocked position; a network interface for providing communication with a communications network; an interface for receiving geolocation information from a geolocation detection device; a sensor for sensing a characteristic related to a user attempting to unlock the locking system; and a processor coupled to the latching mechanism, the network interface, the sensor and the interface for receiving geolocation information.

In operation of such exemplary locking system, the processor is adapted to cause the network interface to transmit to a remote computer server geolocation information and information indicative of a sensed characteristic related to the user attempting to unlock the locking system, and wherein the processor is capable of processing a response signal received by the network interface from the computer server to control the latching mechanism to disengage from the moveable element to enable the moveable element to move into the unlocked position.

An exemplary computer-implemented method performed by the remote computer server consistent with the principles of the invention to enable unlocking of such a mobile locking system includes: (a) receiving information from a lock system representing identification of a user sensed by a sensor associated with the lock system, information indicative of the geolocation of the lock system, and the user attempting to unlock the locking system; (b) receiving information of at least one geolocation where the lock system may be unlocked by an authorized user; processing the sensed information to obtain information indicative of the user; (c) receiving information of an account holder, the account holder information including identification information indicative of the least one user authorized to unlock the lock system; (d) first verifying the received geolocation of the lock system is proximate at least one geolocation where the lock system may be unlocked by an authorized user; (e) second verifying the user attempting to unlock the lock system is authorized to do so based on the user information relative to the received account holder information; and (f) transmitting a first unlock code to the lock system if (i) the first verification step verifies that the enclosure is proximate at least one of the geolocations where the locking system can be unlocked by an authorized user; and (ii) the user information corresponds to the received account holder information of a user of the least one user authorized users to unlock the lock system.

### BRIEF DESCRIPTION OF THE DRAWINGS

Representative embodiments of the present invention are illustrated as examples and are not limited by the figures of the accompanying drawings, in which like references may indicate similar elements and in which:

FIG. 1 depicts an illustrative example of representative components and computer implemented methods which may be found in a system according to various embodiments described herein.

FIG. 2 illustrates a block diagram of an exemplary computer server useable by the system as described in various embodiments herein.

FIG. 3 illustrates a block diagram illustrating an example of a client device which may be used by the system as described in various embodiments herein.

FIG. 4 depicts a block diagram of an exemplary processing unit of a lock system as described in various embodiments herein.

FIG. 5 illustrates a block diagram of an exemplary components useable with the processing unit of FIG. 4.

FIG. 6 is a flow diagram of an exemplary computer-implemented method of a computer server for remotely controlling the unlocking of the lock system according to an embodiment of this disclosure.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the term “computer” refers to a machine, apparatus, or device that is capable of accepting and performing logic operations from software code. The term “application”, “software”, “software code” or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, laptops, tablet PCs including the iPad, cell phones including iOS phones made by Apple Inc., Android OS phones, Blackberry phones, or any electronic device capable of running computer software and displaying information to a user,. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” or sometimes “user device” or just “device” as used herein is a type of computer or computing electronic device generally operated by a person or user of the system. In some embodiments, a client device is a smartphone or computer configured to receive and transmit data to a server or other electronic device which may be operated locally or in the cloud. Non-limiting examples of client devices include: personal computers (PCs), workstations, laptops, tablet PCs including the iPad, cell phones including iOS phones made by Apple Inc., Android OS phones, Blackberry phones, or generally any electronic device capable of running computer software and displaying information to a user. Certain types of client devices which are portable and easily carried by a person from one location to another may sometimes be referred to as a “mobile device.” Some non-limiting examples of mobile devices include: cell phones, smartphones, tablet computers, laptop computers, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wi-Fi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented system and methods for mobile computer-implemented lock systems and methods thereof for providing controllable unlocking based in part on geolocation information associated with the lock systems are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

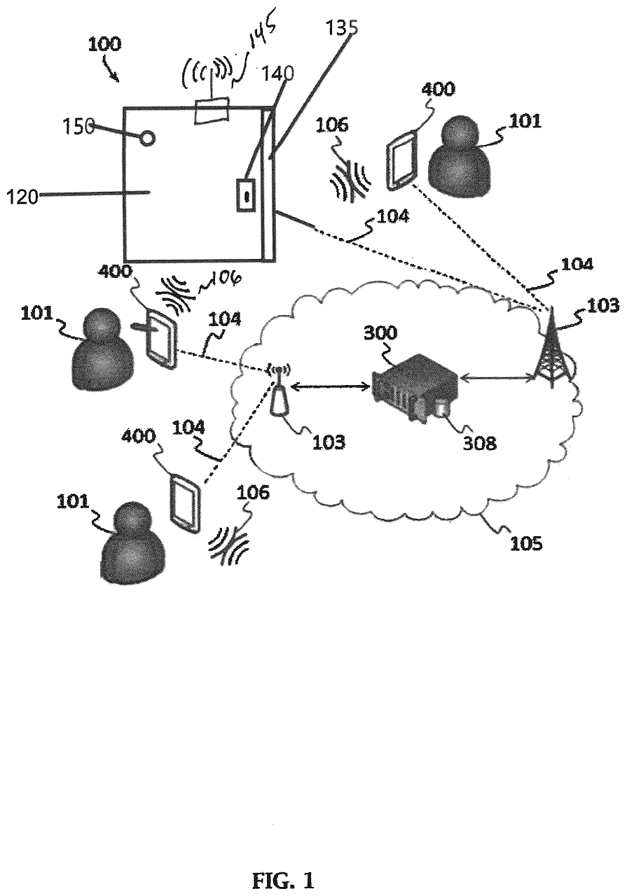

The present invention will now be described by example and through referencing the appended figures representing several embodiments. FIG. 1 depicts an illustrative example of a system 100 for gaining access to a secure mobile enclosure 120 having a lock system 140 according to various embodiments described herein. The system 100 is configured to facilitate the transfer of data and information between one or more access points 103, control systems of the mobile enclosure lock system 140, client devices 400, and servers 300 over a data network 105. Each client device 400 and mobile enclosure lock system 140 may send data to and receive data from the data network 105 through a network connection 104 with an access point 103.

The mobile enclosure 120 may be any enclosure suitable for transportation including, for example, shipping containers, lockable enclosures integrated into, securable to, or located within or on, motor vehicles and the like, such as box trucks, pickup trucks, SUVs, trains, trunks, boxes, lockers (e.g., medicine or police evidence lockers), automobile enclosures such as external accessible enclosures, e.g., passenger compartments, trunks and lockable receptacles, and internal accessible enclosures such as glove boxes and console bins. The locking system 140 for the mobile enclosure 120 may further be, for example, a remotely-controllable padlock device.

A data store 308 accessible by the computer server 300 may contain one or more databases. The data may comprise any information pertinent to one or more users 101 input into the system 100 including information on or describing one or more users 101, information requested by one or more users 101, information supplied by one or more users 101, financial and financial account information, information on one or more delivery addresses, enclosure location, delivery status, courier pick up information, delivery map routing, delivery assignment or general order information the mobile enclosure owner is otherwise associated with, courier background, review ratings, licensing or other government regulation compliance information, and/or any other information which may describe a user 101 or be pertinent to the delivery or retrieval of items of the mobile enclosure 120. As used herein, the user 101 is an individual or business for picking up and/or delivering an item from and/or to the secure enclosure 120.

In this example, the system 100 comprises at least one client device 400 configured to be operated by one or more users 101. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. Additionally, the system 100 may comprise one or more mobile enclosure 120 which may be configured to control access for delivery or retrieval of objects. The present invention may be implemented on at least one mobile enclosure 120, client device 400, and/or computer server 300 programmed to perform one or more of the steps described herein. In some embodiments, more than one mobile enclosure 120, client device 400, and/or computer server 300 may be used, with each being programmed to carry out one or more steps of a method or process described herein.

In some embodiments, the system 100 may be configured to facilitate the communication of information between one or more mobile enclosure 120 and users 101, through their respective client devices 400, and servers 300 of the system 100. Electronic communication 106 between a client device 400 and a mobile enclosure 120 may comprise wireless and/or wired communication. Users of the system 100 may include one or more delivery drivers, delivery couriers, the owner of the enclosure and any person assigned by the owner of the enclosure. In some embodiments, the mobile enclosure 120 may be configured to contain, for example, perishable, valuable or military items, radioactive items and/or power systems generation components in the compartment 50.

Using their client device 400 and the lock system 140, a user 101 may send and receive information with the system 100 that may be used to unlock the lock system 140 and gain access to the contents of the mobile enclosure 120. Once the contents have been placed or retrieved from the mobile enclosure 120, the lock system 140 may record and provide to the system 100 information describing events or actions of the user 101 regarding her/his accessing of the mobile enclosure 120 and/or after the user 101 has accessed the enclosure 120.

FIG. 1 further depicts the mobile enclosure 120 having an exemplary access door 135. The lock system 140 may include electrical and mechanical components, such as for example, a network interface 145 for communicating with the computer server 300 over the data network 105 via an associated network connection 104. These components of the lock system 140 are depicted separate from the lock system 140, for ease of illustration and understanding purposes only. However, it should be readily understood that any or all of such components may be included within or disposed on a housing of the lock system 140. Moreover, a power supply and antennas for wireless communication are associated with the lock system 140, but have not been shown.

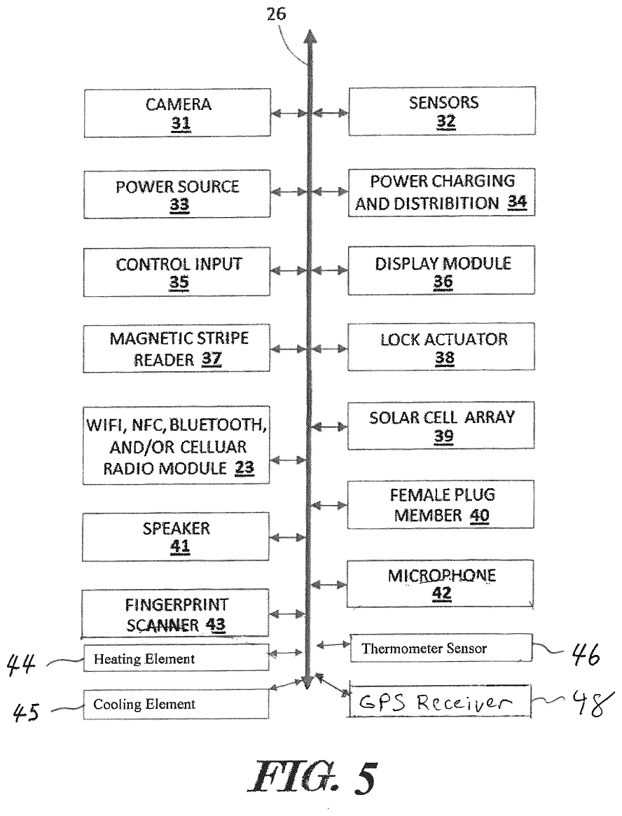

The sensor 150 may be an image capture device, such as a camera, that captures characteristic information associated with the user 101, such as images and videos, for providing to the computer server 300, and/or for storing such information for later reproduction. Suitable cameras useable for the sensor 150 include those cameras described with regard to camera 31 in FIG. 5. Such an image capture device may capture identification information representing image information of the user's face.

In addition, the sensor 150 may be configured to detect or sense other information indicative of the user 101 including, RFID reader, code reader, biometric sensor or microphone, a fingerprint scanner, or biotelemetry sensor, or other detector including, for example, code detectors for reading, for example, bar codes, quick response (QR) codes, or other identification codes. It is possible to utilize a biometric sensor suitable for facial recognition, retinal recognition, and or voice recognition, and/or palm or other body part recognition, and for verifying that the biometric data corresponds to a live person. In such instance, it is possible for the detected biometric data to correspond to a live person by detecting characteristics of signs of life, such as for example, characteristics of blood flow and/or skin temperature.

Other suitable detectors useable for the sensor 150 include detectors for detecting if a NFC tag, card, key fob, or the like is in proximity to the remotely-controllable electronic lock device 140. Optionally, one or more sensors 150 may be integrally formed with the remotely-controllable electronic lock device 140 or in remote wired or wireless communication with the remotely-controllable electronic lock device 140.

The lock system 140 may enable the access door 135 of the enclosure 120 to be locked and unlocked by, for example, electronic, magnetic or electro-magnetic means. As used herein, the remotely-controllable electronic door lock device refers to any remotely-controlled device or system that enables or inhibits access via an associated door of an enclosure, or other mobile lock systems, such as for example, an electronically-controllable padlock.

A controller for the lock system 140 (not shown) may be associated, for example, with an electronic lock manufacturer or a central control system for remotely-controllable electronic lock devices. Suitable lock controllers useable for the remotely-controllable lock system 140 include, but are not limited to, cloud servers that control door lock devices such as, for example, Google Cloud IoT, AWS IoT, GE Predix, Microsoft Azure IoT, IBM Watson IoT, Samsung SmartThings, Wink, and Insteon. As used herein, “cloud servers” are computer servers that are built, hosted and delivered through a cloud computing platform over the Internet. Cloud servers possess and exhibit similar capabilities and functionality to a typical server but are accessed remotely. Servers connected to network hubs such as, for example, Amazon Alexa-enabled devices, Google Home-enabled devices and Samsung SmartThing hub, may also be used for the remotely-controllable electronic lock device 140. The controller may be disposed or located remotely or proximate the remotely-controllable lock system 140.

It should be readily understood that the controller may alternative communicate with the lock system 140 for enabling the locking or unlocking of the access door 135 depending upon the type of electronic lock employed with the access door 135.

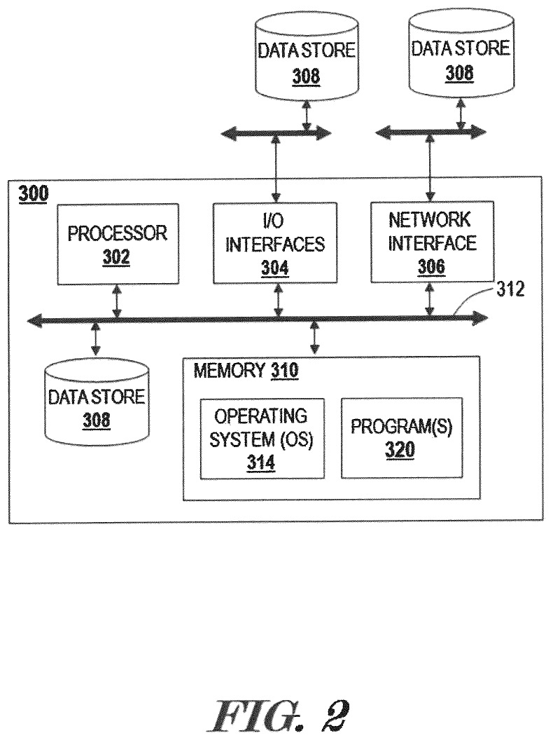

Referring now to FIG. 2, in an exemplary embodiment, a block diagram illustrates a computer server 300 of which one or more may be used in the system 100 or standalone. The computer server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the computer server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the computer server 300, a semiconductor-based microprocessor (in the form of a microchip or chip set), or generally any device for executing software instructions. When the computer server 300 is in operation, the processor 302 is configured to execute software stored within the memory 310, to communicate data to and from the memory 310, and to generally control operations of the computer server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device. I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the computer server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory), nonvolatile memory elements (e.g., ROM, hard drive, tape, and CDROM), and combinations thereof. Moreover, the data store 308 may incorporate electronic, magnetic, optical, and/or other types of storage media. In one example, the data store 308 may be located internal to the computer server 300 such as, for example, an internal hard drive connected to the local interface 312 in the computer server 300. Additionally in another embodiment, the data store 308 may be located external to the computer server 300 such as, for example, an external hard drive connected to the I/O interfaces 304 (. In a further embodiment, the data store 308 may be connected to the computer server 300 through a network, such as, for example, a network attached file server.

The memory 310 may include any of volatile memory elements (e.g., random access memory (RAM,), nonvolatile memory elements (e.g., ROM, hard drive, tape, or CDROM), and combinations thereof. The memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example, Windows-based operating systems available from Microsoft, Corp. of Redmond, WA), LINUX or other UNIX variants available from Red Hat of Raleigh, NC and various other vendors, Android and variants thereof available from Google, Inc. of Mountain View, CA, Apple OS and variants thereof available from Apple, Inc. of Cupertino, CA. The one or more programs 320 may be configured to implement the various processes, algorithms, methods, techniques, etc. described herein.

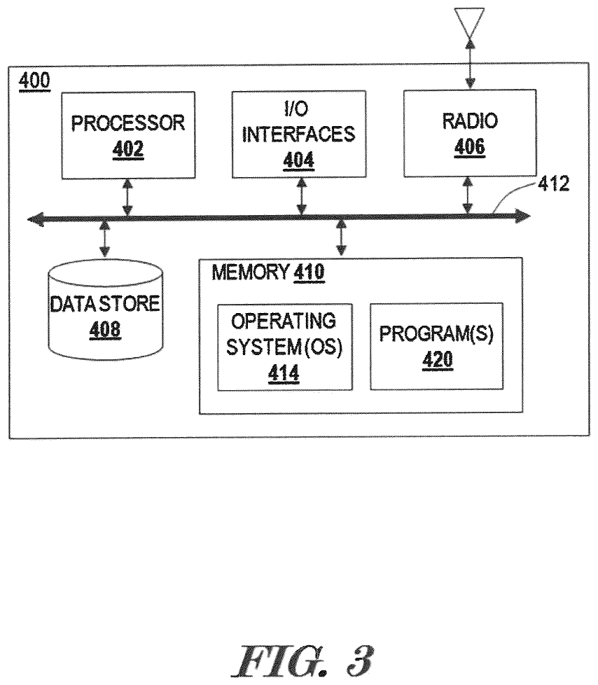

Referring to FIG. 3, in an exemplary embodiment, a block diagram illustrates a client device 400 of which one or more may be used in the system 100 or the like. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display device, touch screen, and the like. The I/O interfaces 404 can also include, for example, a geolocation detection device, such as, for example, a global positioning system (GPS) receiver, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G/5G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM), nonvolatile memory elements (e.g., ROM, hard drive, tape, or CDROM)), and combinations thereof. Moreover, the data store 408 may incorporate electronic, magnetic, optical, and/or other types of storage media.

The memory 410 may likewise may include any of volatile memory elements (e.g., random access memory (RAM), nonvolatile memory elements (e.g., ROM, hard drive, tape, or CDROM)), and combinations thereof. Moreover, the data store 408 may incorporate electronic, magnetic, optical, and/or other types of storage media. The memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX or another UNIX variant, Android, Microsoft Windows and variants thereof, iOS available from Apple, Inc., Blackberry OS available from Research in Motion, and the like. The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to manipulate information of the system 100.

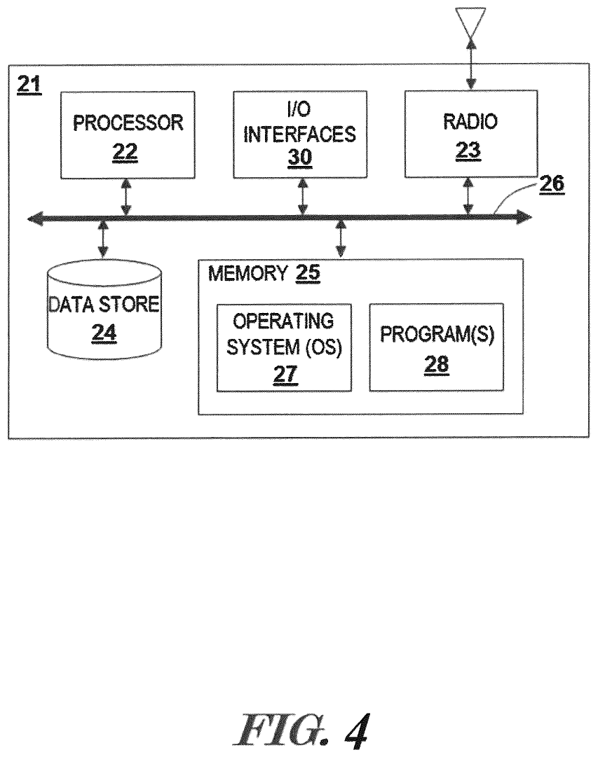

FIGS. 4 and 5 depict exemplary components useable in or with the lock system 140 of the mobile enclosure 120 as described in various embodiments herein. In some embodiments and in the present example, a secure enclosure 120 can be a digital device that, in terms of hardware architecture, comprises a processing unit 21 coupled to other electronic components via a local communication interface 26. As shown in FIG. 4, the processing unit 21 may include a processor 22, one or more input/output (I/O) interfaces 30, an optional radio 23, a data store 24, and memory 25. It should be appreciated by those of ordinary skill in the art that FIGS. 4 and 5 depicts an example of a lock systems 140 in an oversimplified manner, and a practical embodiment may include additional components or elements and suitably configured processing logic to support known or conventional operating features that are not described in detail herein.

The components and elements (22, 30, 23, 24, and 25) are communicatively coupled via a local interface 26. Likewise, the components 31 through 48 depicted in FIG. 5 are likewise in electrical communication with, for example, the processor 22, via the local interface 26. The local interface 26 can be, for example but not limited to, one or more circuit boards, buses, or other wired or wireless connections, as is known in the art. The local interface 26 can have additional elements, which are omitted for simplicity, such as controllers, buffers (caches), drivers, repeaters, and receivers, among many others, to enable communications. Further, the local interface 26 may include address, control, and/or data connections to enable appropriate communications among the aforementioned components.

Referring to FIG. 4, the processor 22 is a hardware device for executing software instructions. The processor 22 can be any custom made or commercially available processor, a central processing unit (CPU), an auxiliary processor among several processors associated with the processing unit 21, a semiconductor-based microprocessor (e.g., in the form of a microchip or chip set), or generally any device for executing software instructions. When the processing unit 21 is in operation, the processor 22 is configured to execute software stored within the memory 25, to communicate data to and from the memory 25, and to generally control operations of the secure lockable enclosure 120 pursuant to the software instructions. In an exemplary embodiment, the processor 22 may include a mobile optimized processor such as optimized for power consumption and mobile applications. The I/O interfaces 30 can be used to output information to a user 101 and to receive user input. Additionally, an I/O interface 30 may comprise a servo, actuator, or other access controlling device which may be used to open and close a compartment in the secure lockable enclosure 120 which may be used to contain delivery or food items.

The I/O interfaces 30 can also include, for example, a serial port, a parallel port, a small computer system interface (SCSI), an infrared (IR) interface, a radio frequency (RF) interface, a universal serial bus (USB) interface, and the like.

One or more radios 23 may enable wireless communication to an external access device, such as a client device 400, or network 105. In some embodiments, a radio 23 may operate on a cellular band and may communicate with or receive a Subscriber Identity Module (SIM) card or other wireless network identifier. Any number of suitable wireless data communication protocols, techniques, or methodologies can be supported by one or more radios 23, including, without limitation: RF; IrDA (infrared); Bluetooth; ZigBee (and other variants of the IEEE 802.15 protocol); IEEE 802.11 (Wi-Fi or any variation); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G/5G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 24 may be used to store data. The data store 24 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 24 may incorporate electronic, magnetic, optical, and/or other types of storage media.

The memory 25 may include any of may include any of volatile memory elements (e.g., random access memory (RAM), nonvolatile memory elements (e.g., ROM, hard drive, tape, or CDROM)), and combinations thereof. Moreover, the data store 408 may incorporate electronic, magnetic, optical, and/or other types of storage media. Moreover, the memory 25 may incorporate electronic, magnetic, optical, and/or other types of storage media. Note that the memory 25 may have a distributed architecture, where various components are situated remotely from one another, but can be accessed by the processor 22. The software in memory 25 can include one or more software programs, each of which includes an ordered listing of executable instructions for implementing logical functions. In the example of FIG. 4, the software in the memory system 25 includes a suitable operating system (O/S) 27 and programs 28. The operating system 27 essentially controls the execution of input/output interface 30 functions, and provides scheduling, input-output control, file and data management, memory management, and communication control and related services. The operating system 27 may be, for example, LINUX or another UNIX variant, Android, Microsoft Windows and/or variants thereof, iOS, Blackberry OS, and the like. The programs 28 may include various applications, add-ons, etc. configured to provide end user functionality with the apparatus 100. For example, exemplary programs 28 may include, but not limited to, a communication application, a verification application, and/or a sensor application.

Numerous embodiments are described herein in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The processing unit 21 may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by the processor 22. In addition, the main memory may be used for storing temporary variables or other intermediate information during the execution of instructions by the processor 22. The processing unit 21 may further include a read only memory (ROM) or other static storage device (e.g., programmable ROM (PROM), erasable PROM (EPROM), and electrically erasable PROM (EEPROM)) coupled to the bus for storing static information and instructions for the processor 22.

In some embodiments as depicted in FIG. 5, a lock system 140 may comprise one or more cameras 31 which may be configured to provide to the computer server 300, or record, still or video images of the environment around the secure lockable enclosure 120 and preferably of a user 101 that is interacting with the lock system 140. In some embodiments, a camera 31 may comprise a digital camera capable of capturing images and/or videos digitally for providing to the computer server 300, and/or for storing images for later reproduction.

As further depicted in FIG. 5, the locking system 140 of the mobile enclosure 120 may comprise one or more sensors 32 which may be configured to provide and record information describing the location of the locking system 140, such as an address, property of where the lock system is presently located. In further embodiments, a sensor 32 may comprise a door lock sensor which may be configured to provide information to the lock system 140 indicating if a door is locked or unlocked and/or open or closed. In further embodiments, a sensor 32 may comprise a sensor configured to provide information to the lock system 140 describing if a magnetic card has been inserted or is present in a magnetic stripe reader 37.

In further embodiments, sensors 32 may comprise a sensor configured to detect information indicative of the user 101 including, for example, a fingerprint scanner 43, or biotelemetry sensor, motion sensor, or other detector including, for example, code detectors for reading, for example, bar codes or quick response codes. Other suitable detectors useable for the sensor 32 include detectors for detecting if a NFC tag, card, key fob, or the like is in proximity to the secure enclosure 120. Optionally, one or more sensors 32 may be integrally formed with the secure enclosure 120 or in remote wired or wireless communication with the secure enclosure 120. In yet further embodiments, the sensor 32 may comprise a sensor or sensors configured to determine the presence or absence of contents within the compartment 50. Such sensors may include, for example, electrical, optical, radiation, magnetic or electro-mechanical sensors. Sensors 32 may additional or alternatively include environment sensors including, for example, microphone, pressure sensor, proximity sensor, temperature sensor, vibration sensor, fluid sensor, moisture sensor, air quality sensor, gas sensor, magnetic sensor, motion sensor, ultrasonic sensor, acoustic sensor, and electromagnetic interference sensor.

The lock system 140 may further comprise a power source 33 which may provide electrical power to any component of a secure enclosure 120 that may require electrical power. A power source 33 may comprise a battery, a fuel cell, a capacitor, or any other type of energy storing and/or electricity releasing device. In further embodiments, a power source 33 may comprise a power cord, kinetic or piezo electric battery charging device, a solar cell or photovoltaic cell, and/or inductive charging or wireless power receiver. In further embodiments, the lock system 140 may also comprise a power charging and distribution module 34 which may be configured to control the recharging of the power source 33, discharging of the power source 33, and/or distribution of power to one or more components of the lock system 140 that may require electrical power.

The secure enclosure 120 may additionally comprise one or more control inputs 35, which may be configured to accept user 101 input to allow a user 101 to interact with the lock system 140. Suitable devices for control input 35 may comprise, for example, a key pad, such as a twelve key keypad, touch sensor display screens or devices, or turntable control knobs, depressible button type switches, slide type switches, rocker type switches, or any other suitable input that a user 101 may physically interact with to control a function of the lock system 140.

In some embodiments, the lock system 140 may comprise one or more display modules 36 which may be configured to output and display visual information to the user 101.

In some embodiments, the lock system 140 may include a magnetic stripe reader 37, which may be a hardware device that reads information encoded in a magnetic stripe located on card, badge, or the like. In further embodiments, a magnetic stripe reader 37 may be an insertion-type reader which requires that the badge or card be inserted into the reader and then pulled out. In still further embodiments, a magnetic stripe reader 37 may be swipe-type reader which requires that the badge or card pass completely through the reader. In other embodiments, a magnetic stripe reader 37 may be any other type or style of reader which may be able to record or receive magnetically encoded information from an object such as a card, badge, or the like.

The lock system 140 may further be configured to manage internal temperatures of the cavity within the mobile enclosures 120 with an environmental controller such as, for example, heating elements 44 and/or cooling elements 45. Suitable heating elements 44 for the secure enclosure 120 may include, for example, heat coils, composite heating elements, Positive Temperature Coefficient “PTC” heating elements and Peltier heat pumps. Suitable cooling elements 45 for the mobile enclosure 120 may include, for example, thermal electric cooling system such as Peltier devices, solid state refrigerators, or thermoelectric coolers (TEC). The processing unit may rely on temperature information from thermometer sensor 46 for operating and/or controlling the heating element 44 and/or cooling element 45. Lastly, an optional geolocation detection device such as for example, a global positioning system (GPS) receiver 48 may process GPS location information signals received by a GPS antenna (not shown) to Further, the secure enclosure may also include some level of insulation.

The mobile enclosure 120 may comprise one or more compartments, such as a cavity, receptacle, or the like, which may be configured to receive perishable and/or non-perishable items. The compartment may be accessible via access door 135 (shown in FIG. 1) or other access controlling portal and also comprise the electronic lock actuator 38 (shown in FIG. 5), which may be configured to control the locking and/or unlocking of the access door 135 (shown in FIG. 1) to the compartment of the enclosure 120. The lock actuator 38 may be operable by a source of energy, typically electric current, hydraulic fluid pressure, or pneumatic pressure, and which converts that energy into motion for the purposes of locking and unlocking the door 135 or other access controlling portal of the compartment. Examples of lock actuators 38 may include comb drives, digital micro-mirror devices, solenoids, electric motors, electroactive polymers, hydraulic cylinders, piezoelectric actuators, pneumatic actuators, servomechanisms, thermal bimorphs, screw jacks, or any other type of hydraulic, pneumatic, electric, mechanical, thermal, and magnetic type of actuators, to cause an unlock of a latching mechanism for the access door 135 or to move such door 135 from a closed and locked position to an open position, and vice-a-versa.

Referring again to FIG. 5, the lock system 140 may comprise a communications port such as a receptacle, for example, female plug member 40 which may be configured to receive and electrically communicate with a male plug member. The female plug member 40 may allow data to be imported and exported from the data store 24 (shown in FIG. 4) of the lock system 140. Optionally, a female plug member 40 may be configured to receive power and to communicate the power to a power source 33, power charging and distribution 34 module, and/or to any other electrical component of the lock system 140. The female plug member 40 may comprise, for example, a female USB connector such as a female micro-USB connector or female mini-USB connector. In other embodiments, an female plug member 40 may comprise a female Type A, B or C USB connector, a female Thunderbolt or Firewire connector, a female multi-pin connector, a female coaxial power connector, a female barrel connector, a female concentric barrel connector, a female tip connector, or any other plug, connector, or receptacle capable of electrical communication with an electronic device.

The female multi-pin connector, a female Pop-Port connector, may further comprise one or more speakers 41, which may be used to produce a plurality of sounds, and one or more microphones 41, which may be configured to pick up or record audio information from the environment of the secure enclosure 120. The speaker 41 may comprise, for example, a buzzer, a piezoelectric sound producing device, a dielectric elastomer sound producing device, a buzzer, a moving coil loudspeaker, an electrostatic loudspeaker, an isodynamic loudspeaker, a piezo-electric loudspeaker, or any other device capable of producing one or more sounds. The microphone 41 may comprise any acoustic-to-electric transducer or sensor that converts sound in air into an electrical signal including, for example, electromagnetic induction microphones (dynamic microphones), capacitance change microphones (condenser microphones), and piezoelectricity microphones (piezoelectric microphones) to produce an electrical signal from air pressure variations.

The lock system 140 may also comprise one or more fingerprint scanners 43 useable to capture a digital image of the fingerprint pattern or other characteristic or otherwise generate a signal indicative of the fingerprint. The captured image may be referred to as a live scan. This live scan may be digitally processed to create a biometric template (a collection of extracted features) which is stored and used for matching. In further embodiments, a fingerprint scanner 43 may operate with technologies including optical, capacitive, radio frequency (RF), thermal, piezo-resistive, ultrasonic, piezoelectric, microelectromechanical systems (MEMS), or any other suitable fingerprint reading technology.

Referring to FIGS. 1 and 2, the computer server 300 may be configured to execute the programs 320 of applications or software rules engines including for example, of a communication application, verification application, and/or sensor application to control the granting and/or denying of access to the compartment 50 of the secure enclosure 120 by an individual. Additionally, data may be sent and received to and from one or more client devices 400 (FIGS. 1 and 3) and lock systems 140 (FIGS. 1, 4, and 5) which may be in (wireless) electronic communication with a computer server 300 through a network 105. In other embodiments, the communication application, verification application, and/or sensor application may be configured to executed by the processing or control units of the lock systems 140, client device 400, and/or the computer server 300 with data transferred to and from one or more servers 300 in communication with a data store 308 through a network 105.

In further embodiments, a completion database may be stored on a data store 408 of a client device 400. A delivery database may comprise any data and information pertinent to one or more users 101 input into the system 100. This data may include user information which may comprise information on or describing one or more users 101. For example, stored user information may include user 101 information such as address or contact information, a photograph or picture of the user 101, fingerprint or other biotelemetry information, financial and financial account information, information on one or more delivery addresses, enclosure location, delivery status, temperature requirements, courier pick up information, enclosure location, delivery map routing, delivery assignment or general order information the delivery courier or lockable enclosure owner is otherwise associated with, courier background, review ratings, licensing or other government regulation compliance information, and/or any other information which may describe a user 101 or be pertinent to the delivery or retrieval of items of the lockable enclosure.

The communication application may comprise a computer program which may be executed by a computing device processor, such as a processors 22, 302 or 402, and which may be configured to govern electronic communication between secure enclosure 120, servers 300, and client devices 400. In some embodiments, the communication application 121 may govern the electronic communication by initiating, maintaining, reestablishing, and terminating electronic communication between one or more secure lockable enclosure 120, servers 300, and client devices 400.

In further embodiments, the communication application may control the network interface 306 of a computer server 300, radio 23 of a secure lockable enclosure 120, and/or radio 406 of a client device 400 to send and receive data to and from one or more lock systems 140, servers 300, and client devices 400 through a network connection 104 (depicted in FIG. 1) over a network 105 (also depicted in FIG. 1). Additionally, the communication application may be configured to store, retrieve, modify, delete, create, or otherwise interact with data in the delivery database 107.

The verification application may comprise a computer program which may be executed by a computing device processor, such as a processors 22, 302, and/or a processor 402, and which may be configured to compare data received from the communication application to data received from the verification application. In some embodiments, the verification application may compare the client input received through the client device 400 of the user 101, such as a photograph of the user taken by a camera I/O interface 404 of a client device 400 and/or a photograph of the user taken by a camera 31 of a secure enclosure 120, to data retrieved by the communication application from the delivery database. In further embodiments, the verification application may compare the client input received through lock systems 140, such as from a camera 31, sensor 32, control input 35, or magnetic stripe reader 37, from the user 101 to data retrieved by the communication application from the delivery database 107. The verification application may be configured to determine if data provided by the lock systems 140 and/or client device 400 of a user 101 matches data, preferably data associated with the user 101 and/or with the property or improvement that the secure lockable enclosure is stationed at, retrieved from the delivery database.

The sensor application may comprise a computer program which may be executed by a computing device processor, such as processors 22, 302, and/or 402, and which may be configured to provide data from one or more sensors 32, such as a door lock sensor, a magnetic card detection sensor, or a NFC tag, card, key fob, sensor to the communication application and/or verification application. Additionally, the sensor application may be configured to provide data from a camera 31, control input 35, magnetic stripe reader 37, and female plug member 40 to the communication application and/or verification application. In further embodiments, the sensor application may be configured control data and power to a display module 36 and lock actuator 38 using data provided by the communication application and/or verification application.

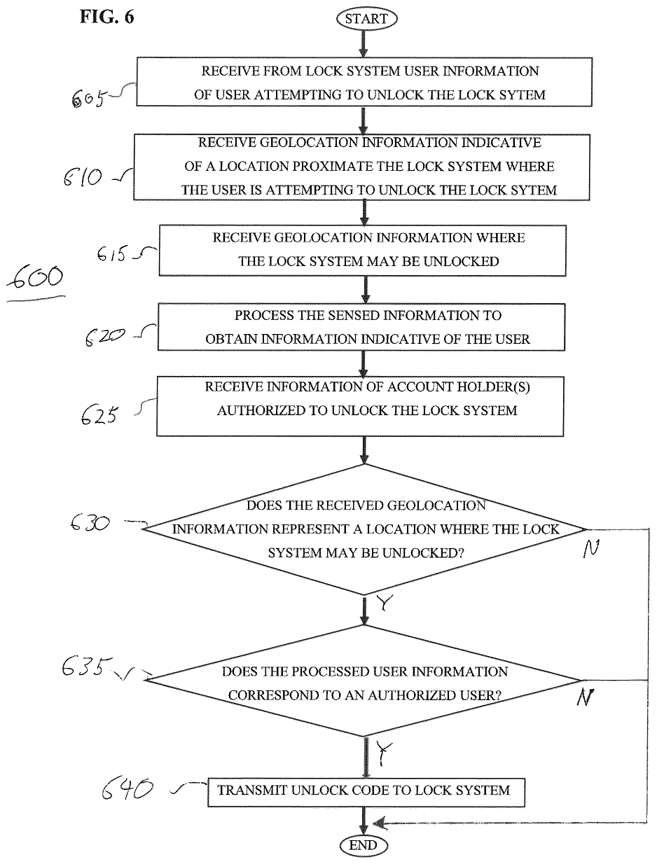

FIG. 6 illustrates a flow diagram of an exemplary computer-implemented method 600 for the computer server 300 for unlocking the lock system 140 by the user 101. One or more steps of the method 600 may be performed by the software programs for the communication application, verification application, and/or sensor application.

The method begins with step 605 for receiving identification information indicative of the user 101 from one or more sensors associated with the lock system 140. In some embodiments, a user 101 may provide identification information to the lock system 140 by allowing, for example in FIG. 5, the camera 31 to capture a image characteristic of the user 101, e.g., face, or the fingerprint sensor 43 to obtain fingerprint information of the user 101.

In step 610, the computer server 300 receives geolocation location information transmitted by the lock system 140. Such geolocation location information may be generated by the optional GPS receiver 48 of the lock system 140, or obtained by the lock system 140 from the client device 400, which include its own GPS receiver (not shown). Then in step 615, the computer server 300 receives geolocation location information where the lock system 140 would be permitted to be unlocked.

In step 620, the sensed user information is then processed to obtain information indicative of the user 101, and in step 625, information is retrieved of an account holder based on either the identification information obtained in step 615, or some other information identifying which particular account holder the user 101 purports to be, or from which group of account holders the user 101 purports to belong. In other embodiments, a user 101 may provide identification information to unlock the lock system 140 by providing input through a control input 35, such as a keypad, by having images of bar codes or quick response (QR) codes, or other identification codes, or by swiping a card, badge, credit card, identification card, or the like, having a magnetic information stripe through a magnetic stripe reader 37. In still further embodiments, a user 101 may provide identification information for unlocking the lock system 140 by communicating identification information through a female (or male) plug member 40 and/or wireless transmissions through a radio 23.

Then, in step 630, the server determines whether the geolocation information received in step 610 corresponds to the geolocation location information where the lock system 140 would be permitted to be unlocked received in step 615. Such correspondence may be, for example, a verification of a specific location or a general geographic area where the lock system 140 may be unlocked. Such information may optionally include the anticipated days and hours during which the lock system 140 may be unlocked/If in step 630, the computer server 300 determines that the geolocation information of the lock system 140 received in step 610 does not corresponds to the geolocation location information where (or the time of day when) the lock system 140 would be permitted to be unlocked, the method 600 ends, and no remote unlocking of the lock system 140 would occur. If, however, the server determines in step 630 that the geolocation information received in step 610 does correspond to the geolocation location information where (or the time of day when) the lock system 140 would be permitted to be unlocked, then the method 600 proceeds to step 635.

In step 635, the user identification information obtained in step 620 and the account holder identification of authorized users received in step 625 are compared by, for example, the verification application of the computer server 300. In some embodiments, the verification application may compare an image of the user 101 taken by the camera 31 against a photographic image of the account holder stored in the delivery database 107 using, for example, facial recognition software or technology. In other embodiments, the verification application may compare fingerprint information or the identification information provided through a control input 35, magnetic strip reader 37, or plug 40 to identification information of the account holder stored in the delivery database 107.

If, in step 635, the computer server 300 determines whether the performed comparison of the user identification information corresponds to, i.e., sufficiently matches, the received account holder information of authorized users. The method 600 proceeds to optional step 640. Otherwise, the method 600 ends with no unlock code being transmitted for unlocking the lock system 140. In step 640 after the computer server 300 determines the user identification information corresponds to the received account holder information of authorized users, the method 600 transmits an unlock code to the lock system for the remotely-controllable lock device 140 by, for example, the communication application for unlocking the lock device 140.

The unlock code may be additionally sent to the client device 400 of the user 101 as a second unlock code. The client device 400 may then communicate the unlock code to the lock system 140, for comparison by the lock system 140 with the (first) unlock code it received from the controller 300, and for unlocking the lock device 140 if the comparison yields a match or correspondence. In an alternative embodiment, the user 100 may manually enter or otherwise the received unlock code on his client device 400 into the control input keypad 35, communications port 40, microphone 42, or by way of a sensor 32 or Wi-Fi, Bluetooth, NFC, or other wireless communication from the client device 400 to the lock system 140, for comparison relative to the unlock code received by the lock system 140 from the controller 300.

the computer server 300, the verification steps 804 and/or 805 may alternatively be performed by a processor within or associated with the lock system 140, such as the processor 22. Further, the method 600 may be used to unlock the locking system 140 to gain access to a compartment within a mobile enclosure. However, it should be readily understood that the mobile locking system 140 may have alternative uses within the scope of the disclosed embodiments herein including, for example, for controlling a lock to secure or prevent removal of an enclosure from a moveable or stationary base, such as removal of a container from a semi-truck container chassis.

In exemplary embodiments, the locking system 140 may be adapted to engage at least one of a king pin of a semi-trailer vehicle, an access door of a moveable enclosure, lashing systems and other cargo securing elements operable with the moveable vehicle. Such moveable vehicle may be, for example. an automobile, truck, shipping container, bus, motorcycle, train, boat, submarine drone, and airplane. The lock system 140 may further be capable of being removed from moveable one vehicle and installed on another vehicle.

In a further embodiment, the method 600 may further include the step of verifying that the user is attempting to unlock the mobile locking system 140 at an permitted or expected time of day, or within a permitted or expected time period. To the extent, that a user would be verified to unlock the lock system 140, and the lock system 140 could be verified that it is at or proximate the location that it may be unlocked, no unlock code would be transmitted by the computer server 300 if the attempt to unlock the lock system 140 occurs at a time that is not permitted by the computer server 300.

In a still further embodiment and for additional security, the processor 302 of server 302, shown in FIG. 2, is adapted to execute a hash key algorithm for generating an anticipated hash key based on at least one of day, time of day, and detected geolocation, and process a signal from the sensor of a code indicative of a corresponding hash key generated by a user device using a counterpart hash key algorithm to generate a hash key for presenting to a sensor of the lock system 140, and wherein the processor 302 is further adapted to confirm whether the sensed code is indicative of the corresponding hash key sensor corresponds to the anticipated hash key.

The method 600 of FIG. 6 may further include the optional steps of transmitting to at least one remote computer server maintaining in a ledger associated with the enclosure, information indicative of the users who at least one of opened or attempted to open the enclosure and a time such at least one opened or attempted to open the enclosure. It is possible for such ledger to be distributed ledger maintained by plurality of computer servers, such as in the form of a blockchain ledger. In such embodiments, it is also advantageous for the processor 302 to receive from at least one of the remote computer servers maintaining in the ledger (or distributed ledger) associated with the lock system 140, information indicative of the user attempting to unlock the lock system 140, whereby such remote computer server performs a zero-knowledge protocol for determining whether the user likely has been authorized for opening the enclosure. Further, it may be advantageous for the ledger to optionally include information indicative of whether the user may deposit or remove an item from the enclosure.

The method 600 may be adapted for greater security by requiring the presence of two authorized users for unlocking of the lock system 140. For example, in such adapted method, the method steps 605 and 615 are modified to receive information from the lock system 140 of representing identification and location of at least two users. Likewise, step 620 and 625 may be revised to processes the sensed information to obtain information indicative of the at least two users, and receive account holder information including identification information indicative of the least two users authorized to unlock said lock system 140. In such an embodiment, the computer server 300 would transmit the unlock code to the lock system 140 if (i) the first verification step verifies that the enclosure is proximate at least one of the geolocations where the lock system may be unlocked by authorized users; and (ii) the processed user information of the at least two users corresponds to the received account holder information of the least two authorized users to unlock the lock system 140.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

The invention is further described by the following numbered paragraphs:
1. A lock system comprising:
   a lock housing adapted for use with a moveable structure;
   a moveable element having a first end disposed within and operatively connected to the lock housing and a second end securable to an item to be locked, said moveable element configured to operate in at least a locked position and an unlocked position;
   an electronically-actuated latching mechanism disposed within said housing and configured to engage the moveable element when said moveable element is in the locked position, and disengage from the moveable element to enable said moveable element to move into the unlocked position;
   a network interface for providing communication with a communications network;
   an interface for receiving geolocation information from a geolocation detection device;
   a sensor for sensing a characteristic related to a user attempting to unlock the lock system; and
   a processor coupled to the latching mechanism, the network interface, the interface for receiving geolocation information and the sensor, wherein said processor is adapted to cause the network interface to transmit to a computer server geolocation information and information indicative of a sensed characteristic related to the user attempting to unlock the locking system, and wherein the processor is capable of processing a response signal received by the network interface from the computer server to control the latching mechanism to disengage from the moveable element to enable said moveable element to move into the unlocked position.
2. The lock system of paragraph 1, wherein the processor, the network interface, the geolocation detection device and the sensor are at least one of disposed within or proximate to the lock housing.
3. The lock system of paragraph 1, wherein the moveable structure is a moveable vehicle, wherein said moveable vehicle is one of an automobile, truck, shipping container, bus, motorcycle, train, boat, submarine drone, and airplane.

4. The lock system of paragraph 1, wherein said the moveable element is adapted to engage at least one of a king pin of a semi-trailer vehicle, an access door of a moveable enclosure, lashing systems and other cargo securing elements operable with the moveable structure.
5. The lock system of paragraph 1, wherein the lock system is capable of being removed from one moveable vehicle and installed on another vehicle.
6. The lock system of paragraph 1, wherein the interface for receiving geolocation information from a geolocation detection device is the network interface.
7. The lock system of paragraph 6, wherein the geolocation detection device is in communication with a user device of the user.
8. The lock system of paragraph 1, further comprising the geolocation detection device coupled to the interface for receiving geolocation information.
9. The lock system of paragraph 1, wherein said sensor is one of an image capture device, RFID reader, code reader, biometric sensor or microphone.
10. The lock system of paragraph 9, wherein said biometric sensor is a fingerprint reader.
11. The lock system of paragraph 9, wherein said sensor is adapted to for use for at least one of facial recognition, retinal recognition, and or voice recognition.
12. The lock system of paragraph 9, wherein said biometric sensor is adapted to for at least one of facial recognition, retinal recognition, voice recognition, and finger, palm or other body part recognition.
13. The lock system of paragraph 9, wherein the biometric sensor is adapted to generate the biometric data corresponding to a live person by detecting characteristics of signs of life.
14. The lock system of paragraph 13, wherein the characteristics of signs of life include at least one of blood flow and skin temperature.
15. The lock system of paragraph 9, wherein said code reader is one of a bar code, RFID or QR-code reader.
16. The lock system of paragraph 1, wherein said processor is configured to receive the unlock code from the communication network.
17. The lock system of paragraph 1, wherein said processor is configured to process information in the response signal related to an account holder to generate an unlock code based on at least a comparison of the received information relative to information indicative of the sensed characteristic related to the user attempting to unlock the locking system.
18. The lock system of paragraph 1, wherein the electronically-actuated latching mechanism comprises a motor for moving the movable element relative to the housing.
19. The lock system of paragraph 1, wherein said processor is disposed separate from the housing.
20. The lock system of paragraph 1, wherein said lock system is coupled to an enclosure having a releasably-lockable access door to a compartment therein, and wherein the locking system is adapted to enable the locking and unlocking of the access door to enable the authorized user to unlock the access door to gain access to the compartment.
21. The lock system of paragraph 20, further comprising a compartment sensor coupled to the processor, wherein the compartment sensor detects the presence or absence of an item within the compartment.
22. The lock system of paragraph 21, further comprising a radiation sensor coupled to the processor and disposed within said enclosure for monitoring radiation levels within said compartment.
23. The lock system of paragraph 21, further comprising an environmental controller comprising at least one of heating or cooling source adapted to provide at least one of heating or cooling to the compartment, wherein said processor is adapted to control the environmental controller based on sensed information indicative of a characteristic of the at least one item placed in the at least one compartment.
24. The lock system of paragraph 23, wherein the sensed information indicative of the characteristic of the item placed in the at least one compartment is at least one of item type, or a desired environmental temperature(s) specified for such delivered item.
25. The lock system of paragraph 1, wherein the moveable element is configured to secure or prevent removal of the enclosure from a base.
26. The lock system of paragraph 25 wherein said base is at least one of moveable and stationary.
27. The lock system of paragraph 1, wherein the processor is adapted to execute a hash key algorithm to generate an anticipated hash key based on at least one of day, time of day, and detected geolocation, and process a signal from the sensor of a code indicative of a corresponding hash key generated by a user device using a counterpart hash key algorithm to generate a hash key for presenting to a sensor of the lock system, and wherein the processor is further adapted to confirm whether the sensed code is indicative of the corresponding hash key sensor corresponds to the anticipated hash key.
28. The lock system of paragraph 1, wherein the processor is adapted to transmit to at least one remote computer server maintaining in a ledger associated with the enclosure, information indicative of the users who at least one of opened or attempted to open the enclosure and a time such at least one opened or attempted to open the enclosure.
29. The lock system of paragraph 28, wherein the ledger maintained by at the at least one computer server is a distributed ledger.
30. The lock system of paragraph 29, wherein the distributed ledger is a blockchain ledger.
31. The lock system of paragraph 1, wherein the processor is adapted to receive from at least one remote computer server maintaining in a ledger associated with the enclosure, information indicative of the user attempting to open the enclosure, said remote server performing aa zero-knowledge protocol for determining whether the user likely has been authorized for opening the enclosure.
32. The lock system of paragraph 31, wherein the processor is further adapted to receive from the at least one remote computer server maintaining in a ledger associated with the enclosure, further information indicative of whether the user may deposit or remove an item from the enclosure.
33. The lock system of paragraph 1 further comprising an environment sensor in wired or wireless electrical communication with the processor.
34. The lock system of paragraph 33, wherein the environment sensor is one of at least one of a microphone, pressure sensor, proximity sensor, temperature sensor, vibration sensor, fluid sensor, moisture sensor, air quality sensor, gas sensor, magnetic sensor, motion sensor, ultrasonic sensor, acoustic sensor, and electromagnetic interference sensor.
35. A computer-implemented method for managing the unlocking of a mobile locking system, the method comprising the steps of:
   receiving information from a lock system representing identification of a user sensed by a sensor associated with the lock system, and information indicative of the geolocation of the lock system;
   receiving information of at least one geolocation where the lock system may be unlocked by an authorized user;
   processing the sensed information to obtain information indicative of the user;
   receiving information of an account holder, said account holder information including identification information indicative of the least one user authorized to unlock said lock system;
   first verifying the received geolocation of the lock system is proximate at least one geolocation where the lock system may be unlocked by an authorized user;
   second verifying the processed information relative to the received account holder information; and
   transmitting a first unlock code to the lock system if (i) the first verification step verifies that the mobile lock system is proximate at least one of the geolocations where the lock system may be unlocked by an authorized user; and (ii) the processed user information corresponds to the received account holder information of a user of the least one user authorized users to unlock said lock system.
36. The computer-implemented method of paragraph 35, wherein the information indicative of the geolocation of the lock system is information of a geolocation of a user device of the user.
37. The computer-implemented method of paragraph 35, wherein the sensor is an image capture device and the sensed identification information by the sensor represents image information of the user's face.
38. The computer-implemented method of paragraph 37, wherein the verifying steps performs a facial recognition process based on the account holder identification information related to the processed image information of the user's face.
39. The computer-implemented method of paragraph 35, wherein the sensor is a code reader and the captured identification information by the sensor represents an identification code.
40. The computer-implemented method of paragraph 35, wherein the verification steps and the transmitting step are performed by a processor associated with the lock system.
41. The computer-implemented method of paragraph 35, further comprising a step of transmitting a second unlock code to the user device associated with the account holder, wherein the first unlock code provided to the locking system corresponds to the second unlock code.
42. The computer-implemented method of paragraph 41, wherein the first unlock code provided to the locking system corresponds to the second unlock code.
43. The computer-implemented method of paragraph 35, wherein said lock system is coupled to an enclosure having a releasably-lockable access door to a compartment therein, and wherein the method is adapted to enable the unlocking of the access door to enable the authorized user to unlock the access door to gain access to the compartment.
44. The computer-implemented method of paragraph 43, further comprising a step of detecting the presence or absence of an item within the compartment based on signals received from a compartment sensor.
45. The computer-implemented method of paragraph 44, further comprising a step of detecting or monitoring radiation levels within said compartment based on signals received from a radiation sensor disposed in or proximate the compartment.
46. The computer-implemented method of paragraph 44, further comprising a step of transmitting signals to an environmental controller to provide at least one of heating or cooling to the compartment, based on sensed information indicative of a characteristic of the at least one item placed in the compartment.
47. The computer-implemented method of paragraph 46, wherein the sensed information indicative of the characteristic of the item placed in the at least one compartment is at least one of item type, or a desired environmental temperature(s) specified for such delivered item.
48. The computer-implemented method of paragraph 35, wherein the moveable element is configured to secure or prevent removal of the enclosure from a base.
49. The computer-implemented method of paragraph 48 wherein said base is at least one of moveable and stationary.
50. The computer-implemented method of paragraph 35, further comprising steps of:
   executing a hash key algorithm to generate an anticipated hash key based on at least one of day, time of day, and detected geolocation,
   processing a signal from the sensor of a code indicative of a code corresponding hash key generated by the user device using a counterpart hash key algorithm, and
   confirming whether the sensed code is indicative of the corresponding hash key sensor corresponds to the anticipated hash key.
51. The computer-implemented method of paragraph 35, further comprising the step of transmitting to at least one remote computer server maintaining in a ledger associated with the enclosure, information indicative of the users who at least one of opened or attempted to open the enclosure and a time such at least one opened or attempted to open the enclosure.
52. The computer-implemented method of paragraph 51, wherein the ledger maintained by at the at least one computer server is a distributed ledger.
53. The computer-implemented method of paragraph 52, wherein the distributed ledger is a blockchain ledger.
54. The computer-implemented method of paragraph 35, further comprising the step of receiving from at least one remote computer server maintaining in a ledger associated with the lock system, information indicative of the user attempting to unlock the lock system, said remote server performing aa zero-knowledge protocol for determining whether the user likely has been authorized for unlocking the lock system.
55. The computer-implemented method of claim 52, further comprising the step of receiving from the at least one remote computer server maintaining in a ledger associated with the enclosure, further information indicative of whether the user may deposit or remove an item from the enclosure.
56. A computer-implemented method for managing the unlocking of a locking system, the method comprising the steps of:
   receiving information from a lock system representing identification of at least two users by a sensor associated with the lock system, and information indicative of the geolocation of the lock system, the at least two users attempting to unlock the locking system;
   receiving information of at least one geolocation where the lock system may be unlocked by an authorized user;
   processing the sensed information to obtain information indicative of the at least two users;
   receiving account holder information including identification information indicative of the least two users authorized to unlock said lock system;
   first verifying the received geolocation of the lock system is proximate at least one geolocation where the lock system may be unlocked by the at least two authorized users;
   second verifying the processed information of the at least two users relative to the received account holder information; and
   transmitting a first unlock code to the lock system if (i) the first verification step verifies that the lock system is proximate at least one of the geolocations where the enclosure system may be opened by an authorized user; and (ii) the processed user information of the at least two users corresponds to the received account holder information of the least two authorized users to unlock said lock system.
57. The computer-implemented method of paragraph 56, wherein the sensed information of the at least two users is predefined security criteria.
58. The computer-implemented method of paragraph 57, wherein the predefined security criteria comprises at least one of biometric data, passcodes, or unique identifiers of the respective at least two users.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims. For example, other suitable applications for the mobile lock system in accordance with this disclosure includes use of the system with moveable enclosures such as mobile medicine lockers for hospitals, nursing homes, home care such as hospice care; package delivery by autonomous vehicles wherein the package is disposed in the trunk or other lockable enclosure of such vehicle; containers for military equipment, radioactive materials, and power systems components, shipping containers for providing access to authorized personnel including inspectors and other government employees; evidence lockers for authorized police personnel; access to passenger compartments of rideshare vehicles or subscription service vehicles.

1. A lock system comprising:
a lock housing adapted for use with a moveable structure;
a moveable element having a first end disposed within and operatively connected to the lock housing and a second end securable to an item to be locked, said moveable element configured to operate in at least a locked position and an unlocked position;
an electronically-actuated latching mechanism disposed within said housing and configured to engage the moveable element when said moveable element is in the locked position, and disengage from the moveable element to enable said moveable element to move into the unlocked position;
a network interface for providing communication with a communications network;
an interface for receiving geolocation information from a geolocation detection device;
a sensor for sensing a characteristic related to a user attempting to unlock the lock system; and
a processor coupled to the latching mechanism, the network interface, the interface for receiving geolocation information and the sensor, wherein said processor is adapted to cause the network interface to transmit to a computer server geolocation information and information indicative of a sensed characteristic related to the user attempting to unlock the locking system. and wherein the processor is capable of processing a response signal received by the network interface from the computer server to control the latching mechanism to disengage from the moveable element to enable said moveable element to move into the unlocked position.

2. The lock system of claim 1, wherein the processor, the network interface, the geolocation detection device and the sensor are at least one of disposed within or proximate to the lock housing.

3. The lock system of claim 1, wherein the moveable structure is a moveable vehicle, wherein said moveable vehicle is one of an automobile, truck, shipping container, bus, motorcycle, train, boat, submarine drone, and airplane.

4. The lock system of claim 1, wherein said the moveable element is adapted to engage at least one of a king pin of a semi-trailer vehicle, an access door of a moveable enclosure, lashing systems and other cargo securing elements operable with the moveable structure.

5. The lock system of claim 1, wherein the lock system is capable of being removed from one moveable vehicle and installed on another vehicle.

6. The lock system of claim 1, wherein the interface for receiving geolocation information from a geolocation detection device is the network interface.

7. The lock system of claim 6, wherein the geolocation detection device is in communication with a user device of the user.

8. The lock system of claim 1, further comprising the geolocation detection device coupled to the interface for receiving geolocation information.

9. The lock system of claim 1, wherein said sensor is one of an image capture device, RFID reader, code reader, biometric sensor or microphone.

10. The lock system of claim 9, wherein the biometric sensor is adapted to generate the biometric data corresponding to a live person by detecting characteristics of signs of life.

11. The lock system of claim 10, wherein the characteristics of signs of life include at least one of blood flow and skin temperature.

12. The lock system of claim 1, wherein said processor is configured to process information in the response signal related to an account holder to generate an unlock code based on at least a comparison of the received information relative to information indicative of the sensed characteristic related to the user attempting to unlock the locking system.

13. The lock system of claim 1, wherein said lock system is coupled to an enclosure having a releasably-lockable access door to a compartment therein, and wherein the locking system is adapted to enable the locking and unlocking of the access door to enable the authorized user to unlock the access door to gain access to the compartment.

14. The lock system of claim 13, further comprising a radiation sensor coupled to the processor and disposed within said enclosure for monitoring radiation levels within said compartment.

15. The lock system of claim 1, wherein the processor is adapted to execute a hash key algorithm to generate an anticipated hash key based on at least one of day, time of day, and detected geolocation, and process a signal from the sensor of a code indicative of a corresponding hash key generated by a user device using a counterpart hash key algorithm to generate a hash key for presenting to a sensor of the lock system, and wherein the processor is further adapted to confirm whether the sensed code is indicative of the corresponding hash key sensor corresponds to the anticipated hash key.

16. The lock system of claim 1, wherein the processor is adapted to transmit to at least one remote computer server maintaining in a ledger associated with the enclosure, information indicative of the users who at least one of opened or attempted to open the enclosure and a time such at least one opened or attempted to open the enclosure.

17. The lock system of claim 16, wherein the ledger maintained by at the at least one computer server is a distributed ledger.

18. The lock system of claim 17, wherein the distributed ledger is a blockchain ledger.

19. The lock system of claim 1, wherein the processor is adapted to receive from at least one remote computer server maintaining in a ledger associated with the lock system, information indicative of the user attempting to unlock the lock system, said remote server performing aa zero-knowledge protocol for determining whether the user likely has been authorized for unlocking the lock system.

20. The lock system of claim 1 further comprising an environment sensor in electrical communication with the processor.

21. The lock system of claim 20, wherein the environment sensor is one of at least one of a microphone, pressure sensor, proximity sensor, temperature sensor, vibration sensor, fluid sensor, moisture sensor, air quality sensor, gas sensor, magnetic sensor, motion sensor, ultrasonic sensor, acoustic sensor, and electromagnetic interference sensor.

22. A computer-implemented method for managing the unlocking of a mobile locking system, the method comprising the steps of;
receiving information from a lock system representing identification of a user sensed by a sensor associated with the lock system, and information indicative of the geolocation of the lock system;
receiving information of at least one geolocation where the lock system may be unlocked by an authorized user;
processing the sensed information to obtain information indicative of the user;
receiving information of an account holder, said account holder information including identification information indicative of the least one user authorized to unlock said lock system;
first verifying the received geolocation of the lock system is proximate at least one geolocation where the lock system may be unlocked by an authorized user;
second verifying the processed information relative to the received account holder information; and
transmitting a first unlock code to the lock system if (i) the first verification step verifies that the mobile lock system is proximate at least one of the geolocations where the lock system may be unlocked by an authorized user; and (ii) the processed user information corresponds to the received account holder information of a user of the least one user authorized users to unlock said lock system.

23. The computer-implemented method of claim 22, wherein the information indicative of the geolocation of the lock system is information of a geolocation of a user device of the user.

24. The computer-implemented method of claim 22, wherein the sensor is an image capture device and the sensed identification information by the sensor represents image information of the user's face.

25. The computer-implemented method of claim 24, wherein the verifying steps performs a facial recognition process based on the account holder identification information related to the processed image information of the user's face.

26. The computer-implemented method of claim 22, wherein the sensor is a code reader and the captured identification information by the sensor represents an identification code.

27. The computer-implemented method of claim 22, further comprising a step of transmitting a second unlock code to the user device associated with the account holder, wherein the first unlock code provided to the locking system corresponds to the second unlock code.

28. The computer-implemented method of claim 22, further comprising steps of:
executing a hash key algorithm to generate an anticipated hash key based on at least one of day, time of day, and detected geolocation,
processing a signal from the sensor of a code indicative of a code corresponding hash key generated by the user device using a counterpart hash key algorithm, and
confirming whether the sensed code is indicative of the corresponding hash key sensor corresponds to the anticipated hash key.

29. The computer-implemented method of claim 22, further comprising the step of transmitting to at least one remote computer server maintaining in a ledger associated with the enclosure, information indicative of the users who at least one of opened or attempted to open the enclosure and a time such at least one opened or attempted to open the enclosure.

30. The computer-implemented method of claim 29, wherein the ledger maintained by at the at least one computer server is a distributed ledger.

31. The computer-implemented method of claim 30, wherein the distributed ledger is a blockchain ledger.

32. The computer-implemented method of claim 22, further comprising the step of receiving from at least one remote computer server maintaining in a ledger associated with the lock system, information indicative of the user attempting to unlock the lock system, said remote server performing aa zero-knowledge protocol for determining whether the user likely has been authorized for unlocking the lock system.

33. A computer-implemented method for managing the unlocking of a locking system, the method comprising the steps of:
receiving information from a lock system representing identification of at least two users by a sensor associated with the lock system, and information indicative of the geolocation of the lock system, the at least two users attempting to unlock the locking system;
receiving information of at least one geolocation where the lock system may be unlocked by an authorized user;
processing the sensed information to obtain information indicative of the at least two users;
receiving account holder information including identification information indicative of the least two users authorized to unlock said lock system;
first verifying the received geolocation of the lock system is proximate at least one geolocation where the lock system may be unlocked by the at least two authorized users;
second verifying the processed information of the at least two users relative to the received account holder information; and
transmitting a first unlock code to the lock system if (i) the first verification step verifies that the lock system is proximate at least one of the geolocations where the enclosure system may be opened by an authorized user; and (ii) the processed user information of the at least two users corresponds to the received account holder information of the least two authorized users to unlock said lock system.
